(19) United States
(12) Patent Application Publication
(10) Pub. No.: US 2025/0079501 A1
(43) Pub. Date: Mar. 6, 2025

(54) ALL-SOLID-STATE BATTERY

(71) Applicant: SAMSUNG ELECTRO-MECHANICS CO., LTD., Suwon-si, Gyeonggi-do (KR)

(72) Inventors: Myung Jin Jung, Suwon-si, Gyeonggi-do (KR); Namgyu Kim, Suwon-si, Gyeonggi-do (KR); Jieun Wang, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/287,568

(22) PCT Filed: Sep. 27, 2023
(86) PCT No.: PCT/KR2023/015010

§ 371 Date: Oct. 19, 2023

(30) Foreign Application Priority Data
Feb. 16, 2023 (KR) 10-2023-0020957

(51) Int. Cl. H01M 10/0562; H01M 10/0585; H01M 50/593

(52) U.S. Cl. CPC H01M 10/0562; H01M 10/0585; H01M 50/593; H01M 2300/0065

(57) ABSTRACT

An all-solid-state battery includes a solid electrolyte layer and a first electrode layer and a second electrode layer disposed in a stacking direction with the solid electrolyte layer interposed therebetween, and having different polarities. Each of the first electrode layer and the second electrode layer includes a central portion and an outer portion located outside the central portion. The central portions of the first electrode layer and the second electrode layer overlap each other and overlap the solid electrolyte layer in the stacking direction. The outer portions of the first electrode layer and the second electrode layer overlap the solid electrolyte layer in the stacking direction, and have corner portions located on opposite sides to each other along a diagonal direction in different electrode layers.

### TECHNICAL FIELD

The present disclosure relates to an all-solid-state battery.

### BACKGROUND ART

As the long-term use of portable electronic devices is common, high capacity batteries are required, and safety of batteries is required due to the popularization of wearable electronic devices. Therefore, the development of an all-solid-state battery using a solid electrolyte instead of a liquid electrolyte is actively progressing.

The all-solid-state battery is a battery that replaces the existing liquid electrolyte with a solid electrolyte, and may greatly reduce the risk of explosion due to the inflammability of the liquid electrolyte and may be stably operated even in a harsh environment of relatively high temperature and high pressure since it does not use the liquid electrolyte. In addition, since cells may be stacked without a separate cooling unit and high energy density may be realized in the same volume, the all-solid-state batteries are expected to be used in the future.

The above information disclosed in this Background section is only for enhancement of understanding of the background of the described technology, and therefore it may contain information that does not form the prior art that is already known to a person of ordinary skill in the art.

### DISCLOSURE OF INVENTION

### Technical Problem

The described technology has been made in an effort to provide an all-solid-state battery capable of increasing battery capacity and improving charge and discharge rates within a given volume.

However, problems to be solved by embodiments are not limited to the abovementioned problems, and can be variously expanded within the scope of the technical idea included in the present invention.

### Solution to Problem

An embodiment provides an all-solid-state battery including a solid electrolyte layer and a first electrode layer and a second electrode layer disposed in a stacking direction with the solid electrolyte layer interposed therebetween, and having different polarities. Each of the first electrode layer and the second electrode layer includes a central portion and an outer portion located outside the central portion. The central portions of the first electrode layer and the second electrode layer overlap each other and overlap the solid electrolyte layer in the stacking direction. The outer portions of the first electrode layer and the second electrode layer overlap the solid electrolyte layer in the stacking direction, and have corner portions located on opposite sides to each other along a diagonal direction in different electrode layers.

The central portion may include four edges. The outer portion may include two linear portions that are bent at the corner portion and integrally connected, and may be in contact with the whole of two adjacent edges of the central portion.

The all-solid-state battery may further include an insulating layer in contact with each of the first electrode layer and the second electrode layer in a planar direction. The insulating layer may include two linear portions that are bent and integrally connected, and may be in contact with the whole of other two edges of the central portion and an end portion of the outer portion.

The central portion may include four edges. The outer portion may include two linear portions that are bent at the corner portion and integrally connected, and may be in contact with the whole of one edge and a portion of the other edge of the central portion.

The all-solid-state battery may further include an insulating layer in contact with each of the first electrode layer and the second electrode layer in a planar direction. The insulating layer may include three linear portions that are bent and integrally connected, and may be in contact with a whole of other two adjacent edges of the central portion, the rest of the other edge, and an end portion of the outer portion.

The solid electrolyte layer may include two corner portions facing in a diagonal direction. The first electrode layer and the second electrode layer may be symmetrical to each other based on an imaginary line connecting vertices of the two corner portions.

The solid electrolyte layer may include a first corner portion and a second corner portion facing in a diagonal direction.

The corner portion of the outer portion of the first electrode layer may overlap the first corner portion in the stacking direction. The corner portion of the outer portion of the second electrode layer may overlap the second corner portion in the stacking direction.

The solid electrolyte layer may include a first edge portion and a second edge portion in contact with the first corner portion, and a third edge portion and a fourth edge portion in contact with the second corner portion. An outer portion edge of the first electrode layer may overlap a portion of the first edge portion and a portion of the second edge portion in the stacking direction. An outer portion edge of the second electrode layer may overlap a portion of the third edge portion and a portion of the fourth edge portion in the stacking direction.

The all-solid-state battery may further include a first insulating layer and a second insulating layer in contact with each of the first electrode layer and the second electrode layer in a planar direction. An edge of the first insulating layer may overlap the rest of the first edge portion, the rest of the second edge portion, the third edge portion, and the fourth edge portion in the stacking direction. An edge of the second insulating layer may overlap the first edge portion, the second edge portion, the rest of the third edge portion, and the rest of the fourth edge portion in the stacking direction.

The outer portions of the first electrode layer and the second electrode layer and each of the first insulating layer and the second insulating layer may include two linear portions that are bent and integrally connected. The outer portion of the first electrode layer and the first insulating layer may form a quadrangular frame to surround the central portion of the first electrode layer. The outer portion of the second electrode layer and the second insulating layer may form a quadrangular frame to surround the central portion of the second electrode layer.

The outer portions of the first electrode layer and the second electrode layer may include two linear portions that are bent at the corner portion and integrally connected. Each of the first insulating layer and the second insulating layer may include three linear portions that are bent and integrally connected. The outer portion of the first electrode layer and the first insulating layer may form a quadrangular frame to surround the central portion of the first electrode layer, and the outer portion of the second electrode layer and the second insulating layer may form a quadrangular frame to surround the central portion of the second electrode layer.

Another embodiment provides an all-solid-state battery including a solid electrolyte layer, a first electrode layer and a second electrode layer disposed in a stacking direction with the solid electrolyte layer interposed therebetween, and having different polarities, and a first external electrode and a second external electrode connected to the first electrode layer and the second electrode layer, respectively. Each of the first electrode layer and the second electrode layer includes a central portion and an outer portion located outside the central portion. The central portion overlaps the solid electrolyte layer and different electrode layers in the stacking direction. The outer portion may include corner portions overlapping the solid electrolyte layer in the stacking direction and located on opposite sides to each other along a diagonal direction in different electrode layers, and two linear portions that are bent at the corner portion and integrally connected. The first external electrode and the second external electrode may be connected to two adjacent edges of the outer portion.

The all-solid-state battery may further include a first insulating layer. The first insulating layer may be in contact with the first electrode layer in a planar direction and have two linear portions that are bent and integrally connected. The outer portion of the first electrode layer and the first insulating layer may form a quadrangular frame to surround the central portion of the first electrode layer.

The all-solid-state battery may further include a second insulating layer. The second insulating layer may be in contact with the second electrode layer in a planar direction and have two linear portions that are bent and integrally connected. The outer portion of the second electrode layer and the second insulating layer may form a quadrangular frame to surround the central portion of the second electrode layer.

The all-solid-state battery may further include a first insulating layer. The first insulating layer may be in contact with the first electrode layer in a planar direction and have three linear portions that are bent and integrally connected. The outer portion of the first electrode layer and the first insulating layer may form a quadrangular frame to surround the central portion of the first electrode layer.

The all-solid-state battery may further include a second insulating layer. The second insulating layer may be in contact with the second electrode layer in a planar direction and have three linear portions that are bent and integrally connected. The outer portion of the second electrode layer and the second insulating layer may form a quadrangular frame to surround the central portion of the second electrode layer.

The solid electrolyte layer may include two corner portions facing in a diagonal direction. The outer portions of the first electrode layer and the second electrode layer may be symmetrical to each other based on an imaginary line connecting vertices of the two corner portions.

The solid electrolyte layer, the first electrode layer, and the second electrode layer may constitute a cell stack. The solid electrolyte layer may include a first corner portion and a second corner portion facing in a diagonal direction. The first external electrode may surround the first corner portion and contact two adjacent side surfaces of the cell stack, and the second external electrode may surround the second corner portion and contact other two adjacent side surfaces of the cell stack.

### Advantageous Effects of Invention

According to an embodiment, an all-solid-state battery may increase a capacity of an electrode active material layer within a given volume to increase a battery capacity, and shorten an electron movement path between an electrode layer and an external electrode to increase a charge/discharge rate.

### BRIEF DESCRIPTION OF DRAWINGS

FIG. 1 is a perspective view illustrating an all-solid-state battery according to an embodiment.

FIG. 2 is a cross-sectional view taken along line II-II′ of FIG. 1.

FIG. 3 is a partially exploded perspective view illustrating a partially disassembled all-solid-state battery illustrated in FIG. 1.

FIG. 4 is a partially exploded perspective view illustrating a partially disassembled all-solid-state battery according to Comparative Example.

FIG. 5 is a diagram schematically illustrating an electron movement path between an electrode layer and an external electrode in the all-solid-state battery of Comparative Example illustrated in FIG. 4.

FIG. 6 is a diagram schematically illustrating an electron movement path between the electrode layer and the external electrode in the all-solid-state battery of the embodiment illustrated in FIG. 1.

FIG. 7 is a perspective view illustrating an all-solid-state battery according to another embodiment.

FIG. 8 is a partially exploded perspective view illustrating a partially disassembled all-solid-state battery illustrated in FIG. 7.

FIG. 9 is a graph showing results of a cole-cole plot of the all-solid-state batteries according to Examples 1 and 2 and Comparative Example.

### MODE FOR THE INVENTION

Hereinafter, embodiments of the present disclosure will be described in detail with reference to the accompanying drawings so that those skilled in the art to which the present disclosure pertains may easily practice the present disclosure. In order to clearly explain the present disclosure in the drawings, parts irrelevant to the description are omitted, and the same reference numerals are used for the same or similar components throughout the specification. In addition, it is to be noted that some components shown in the drawings are exaggerated, omitted or schematically illustrated, and the size of each component does not exactly reflect its real size.

It should be understood that the accompanying drawings are provided only in order to allow embodiments of the present disclosure to be easily understood, and the spirit of the present disclosure is not limited by the accompanying drawings, but includes all the modifications, equivalents, and substitutions included in the spirit and the scope of the present disclosure.

Terms including an ordinal number such as first, second, etc., may be used to describe various components, but the components are not limited to these terms. The terms are used only to distinguish one component from another component.

In addition, it will be understood that when an element such as a layer, a film, a region, or a substrate is referred to as being “on” another element, it may be “directly on” another element or may have an intervening element present therebetween. To the contrary, it will be understood that when any element is referred to as being “directly on” another element, an element may be not present therebetween. In addition, when an element is referred to as being “on” a reference element, it can be positioned on or beneath the reference element, and is not necessarily positioned “over” or “on” the reference element in an opposite direction to gravity.

It will be further understood that the terms “include” or “have” used in the present specification, specify the presence of features, numerals, steps, operations, components, parts mentioned in the present specification, or a combination thereof, but do not preclude the presence or addition of one or more other features, numerals, steps, operations, components, parts, or a combination thereof. Accordingly, unless explicitly described to the contrary, “comprising” any components will be understood to imply the inclusion of other components rather than the exclusion of other components.

Throughout the specification, the word “plan view” refers to a view when a target is viewed from the top, and the word “cross-sectional view” refers to a view when a cross section of a target taken along a vertical direction is viewed from the side.

Throughout the specification, when it is said to be “connected”, this does not mean that two or more components are directly connected, but means that two or more components are indirectly connected through another component, that two or more components are physically connected as well as electrically connected, or that two or more components are referred to by different names depending on their location or function, but are integral.

In the description of the all-solid-state battery in this specification, the direction in which the main components of the all-solid-state battery are stacked is defined as the “stacking direction”, but it may also be the “thickness direction”. In addition, a direction parallel to a plane perpendicular to the stacking direction may be defined as a “plane direction”, and the plane direction may include a “first direction” and a “second direction” orthogonal to each other.

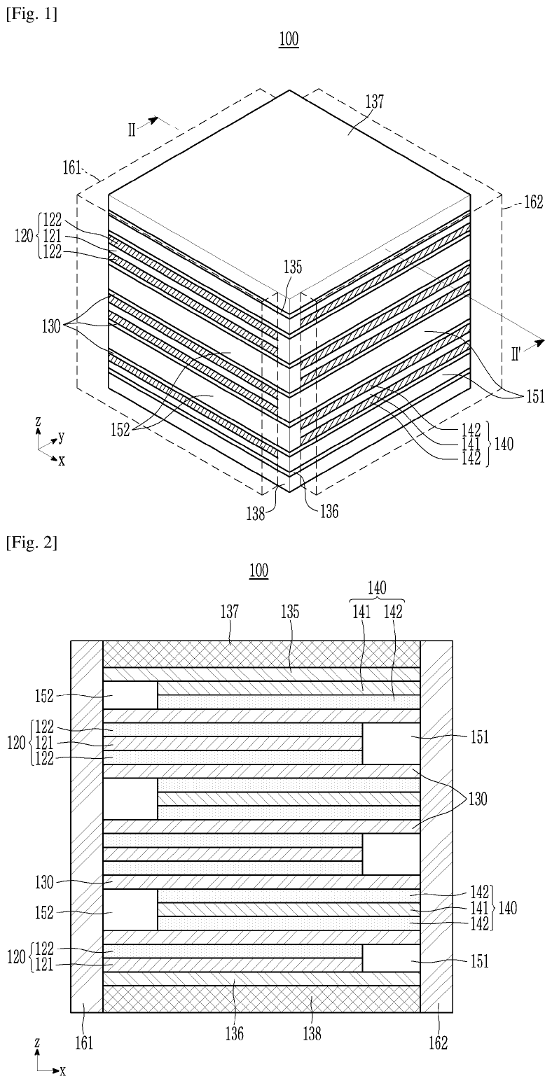

FIG. 1 is a perspective view illustrating an all-solid-state battery according to an Example embodiment, and FIG. 2 is a cross-sectional view taken along line II-II′ of FIG. 1.

Referring to FIGS. 1 and 2, an all-solid-state battery 100 according to an embodiment includes electrode layers 120 and 140 and a solid electrolyte layer 130 located adjacent to the electrode layers 120 and 140 in a stacking direction (z-axis direction in the drawing). The electrode layers 120 and 140 may basically include current collectors 121 and 141 extending in a planar direction (x-y plane direction in the drawing) and electrode active material layers 122 and 142 located on at least one surface of the current collectors 121 and 141.

In this embodiment, the electrode layers 120 and 140 include a positive electrode layer 120 and an negative electrode layer 140 having different polarities. The solid electrolyte layer 130 includes a solidified electrolyte and may function as a medium for transferring ions between the positive electrode layer 120 and the negative electrode layer 140. The positive electrode layer 120 may be a first electrode layer, and the negative electrode layer 140 may be a second electrode layer.

The positive electrode layer 120 includes the positive electrode current collector 121 and the positive electrode active material layer 122 located on at least one surface of the positive electrode current collector 121. The negative electrode layer 140 includes an negative electrode current collector 141 and an negative electrode active material layer 142 located on at least one surface of the negative electrode current collector 141. The electrode active material layers 122 and 142 may be located on the whole of one surface of the current collectors 121 and 141.

For example, the negative electrode layer 140 located at the top in the stacking direction may include the negative electrode active material layer 142 located on one surface (lower surface) of the negative electrode current collector 141, and the positive electrode layer 120 located at the bottom may include the positive electrode active material layer 122 located on one surface (upper surface) of the positive electrode current collector 121. In addition, the positive electrode layers 120 located between the top and bottom may include the positive electrode active material layer 122 located on both surfaces of the positive electrode current collector 121, and the negative electrode layers 140 located between the top and the bottom may include the negative electrode active material layer 142 located on both surfaces of the negative electrode current collector 141.

The solid electrolyte layer 130 may be adjacently disposed between the positive electrode active material layer 122 of the positive electrode layer 120 and the negative electrode active material layer 142 of the negative electrode layer 140 in the stacking direction. Therefore, within the all-solid-state battery 100, the plurality of positive electrode layers 120 and the plurality of negative electrode layers 140 may be alternately arranged, and the solid electrolyte layer 130 may be interposed and stacked between the negative electrode layer 120 and the positive electrode layer 140.

For example, a garnet type solid electrolyte, a Li super ionic conductor (LiSICON) type solid electrolyte, a perovskite type solid electrolyte, a Na super ionic conductor (NaSICON) type solid electrolyte, etc., may be used as the solid electrolyte layer 130.

The positive electrode layer 120, the solid electrolyte layer 130, and the negative electrode layer 140 may be stacked as described above to constitute a cell stack of the all-solid-state battery 100. An outer insulating layer 135 covering the negative electrode current collector 141 may be located at the upper outermost portion of the cell stack, and an outer insulating layer 136 covering the positive electrode current collector 121 may be located at the lower outermost portion of the cell stack. In addition, protective layers 137 and 138 including an insulating material are additionally located outside the outer insulating layers 135 and 136 to prevent ion leakage and secure insulation performance.

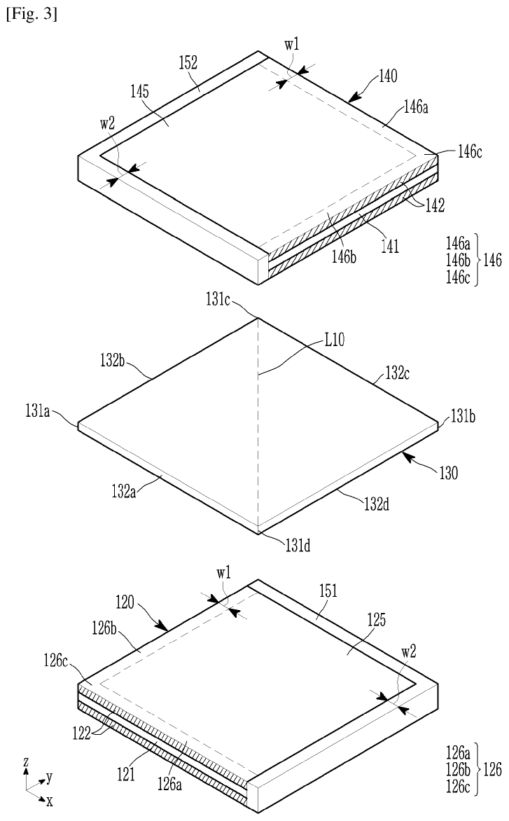

FIG. 3 is a partially exploded perspective view illustrating a partially disassembled all-solid-state battery illustrated in FIG. 1.

Referring to FIG. 3, the positive electrode layer 120, the solid electrolyte layer 130, and the negative electrode layer 140 are configured as a polygon on a plane, and may be configured as, for example, a quadrangle.

The solid electrolyte layer 130 may include a first corner portion 131a and a second corner portion 131b facing each other in a diagonal direction, a first edge portion 132a and a second edge portion 132b contacting the first corner portion 131a, and a third edge portion 132c and a fourth edge portion 132d contacting the second corner portion 131b. The second edge portion 132b and the third edge portion 132c may contact the third corner portion 131c, and the first edge portion 132a and the fourth edge portion 132d may contact the fourth corner portion 131d.

The first edge portion 132a and the third edge portion 132c may be parallel to a first direction (x-axis direction in the drawing), and the second edge portion 132b and the fourth edge portion 132d may be parallel to a second direction (y-axis direction in the drawing). The first edge portion 132a and the third edge portion 132c face each other along the second direction, and the second edge portion 132b and the fourth edge portion 132d face each other along the first direction.

The positive electrode layer 120 may include a central portion 125 and an outer portion 126 located outside the central portion 125. The central portion 125 may have a quadrangular shape, and the outer portion 126 may include two linear portions 126a and 126b that are bent and integrally connected, and may be in contact with all two adjacent edges of the central portion 125. The outer portion 126 includes a corner portion 126c located between two linear portions 126a and 126b. The corner portion 126c of the outer portion 126 may overlap the first corner portion 131a in the stacking direction, and edges of the two linear portions 126a and 126b of the outer portion 126 may overlap a portion of the first edge portion 132a and a portion of the second edge portion 132b in the stacking direction.

The positive electrode layer 120 may contact the insulating layer 151 in the planar direction. The insulating layer 151 may include two linear portions that are bent and integrally connected, and be in contact with the entirety of remainder of the edges of the central portion 125 and an end portion of the outer portion 126. The insulating layer 151 may form a quadrangular frame together with the outer portion 126 to surround the central portion 125 without gaps.

The combined area of the positive electrode layer 120 and the insulating layer 151 may be equal to that of the solid electrolyte layer 130. A corner of the insulating layer 151 may overlap the second corner portion 131b in the stacking direction, and two edges of the insulating layer 151 may overlap the entirety of the third edge portion 132c and the entirety of the fourth edge portion 132d in the stacking direction.

The negative electrode layer 140 may include a central portion 145 and an outer portion 146 located outside the central portion 146. The central portion 145 may have a quadrangular shape, and the outer portion 146 may include two linear portions 146a and 146b that are bent and integrally connected, and may be in contact with all two adjacent edges of the central portion 145. The outer portion 146 includes a corner portion 146c located between the two linear portions 146a and 146b. The corner portion 146c of the outer portion 146 may overlap the second corner portion 131b in the stacking direction, and two edges of the outer portion 146 may overlap a portion of the third edge portion 132c and a portion of the fourth edge portion 132d in the stacking direction.

The negative electrode layer 140 may contact the insulating layer 152 in the planar direction. The insulating layer 152 may include two linear portions that are bent and integrally connected, and be in contact with the entirety of remainder of the edges of the central portion 145 and an end portion of the outer portion 146. The insulating layer 152 may form a quadrangular frame together with the outer portion 146 to surround the central portion 145 without gaps.

The combined area of the negative electrode layer 140 and the insulating layer 152 may be equal to that of the solid electrolyte layer 130. The corner of the insulating layer 152 may overlap the first corner portion 131a in the stacking direction, and two edges of the insulating layer 152 may overlap the entirety of the first edge portion 132a and the entirety of the second edge portion 132b in the stacking direction.

The central portion 125 of the positive electrode layer 120 overlaps the central portion 145 of the solid electrolyte layer 130 and the negative electrode layer 140 in the stacking direction. That is, the central portions 125 and 145 overlap the solid electrolyte layer 130 and other electrode layers in the stacking direction. The outer portion 126 of the positive electrode layer 120 overlaps the solid electrolyte layer 130 in the stacking direction, but does not overlap the negative electrode layer 140. The outer portion 146 of the negative electrode layer 140 overlaps the solid electrolyte layer 130 in the stacking direction, but does not overlap the positive electrode layer 120.

That is, the outer portions 126 and 146 have the corner portions 126c and 146c located on opposite sides to each other along the diagonal direction and do not overlap other electrode layers in the stacking direction. All of the outer portions 126 and 146 are also located on opposite sides of each other along the diagonal direction, and face each other along the diagonal direction.

The insulating layer 151 in contact with the positive electrode layer 120 may be the first insulating layer, and the insulating layer 152 in contact with the negative electrode layer 140 may be the second insulating layer. The outer portion 126 of the positive electrode layer 120 overlaps the solid electrolyte layer 130 and the second insulating layer 152 in the stacking direction, and the outer portion 146 of the negative electrode layer 140 overlaps the solid electrolyte layer 130 and the first insulating layer 151 in the stacking direction. The positive electrode layer 120 and the negative electrode layer 140 may be symmetrical with respect to an imaginary line L10 connecting vertices of the third corner portion 131c and the fourth corner portion 131d.

Referring FIGS. 1 to 3, two adjacent edges of the positive electrode layer 120 and two adjacent edges of the negative electrode layer 140 may be exposed to side surfaces of the cell stack, and the external electrodes 161 and 162 may be connected and coupled to two adjacent edges of the exposed positive electrode layer 120 and two adjacent edges of the negative electrode layer 140. The external electrodes 161 and 162 may include an external positive electrode 161 that is connected to the positive electrode layer 120 and has a positive electrode and an external negative electrode 162 that is connected to the negative electrode layer 140 and has a negative electrode. The external positive electrode 161 may be a first external electrode, and the external negative electrode 162 may be a second external electrode.

Two adjacent edges of the positive electrode layer 120, specifically, two adjacent edges of the outer portion 126 may be exposed to two side surfaces of the cell stack, and the external positive electrode 161 may surround the first corner portion 131a and may be located in contact with two adjacent side surfaces of the cell stack. Two adjacent edges of the negative electrode layer 140, specifically, two adjacent edges of the outer portion 146 may be exposed to other two side surfaces of the cell stack, and the external negative electrode 162 may surround the second corner portion 131b and may be located in contact with other two adjacent side surfaces of the cell stack.

The insulating layers 151 and 152 are located between the positive electrode layer 120 and the external negative electrode 162 and between the negative electrode layer 140 and the external positive electrode 161 to insulate them from each other. The outer portions 126 and 146 and the insulating layers 151 and 152 may have a constant width, and a width w1 of the outer portions 126 and 146 and a width w2 of the insulating layers 151 and 152 may be equal to each other.

The above-described all-solid-state battery 100 is configured to maximize the area of the electrode active material layers 122 and 142 within a given volume and expand the contact area between the electrode layers 120 and 140 and the external electrodes 161 and 162. Therefore, the above-described all-solid-state battery 100 may increase the battery capacity by increasing the capacity of the electrode active material layers 122 and 142, and may shorten an electron movement path between the electrode layers 120 and 140 and the external electrodes 161 and 162 to increase the charge/discharge rate.

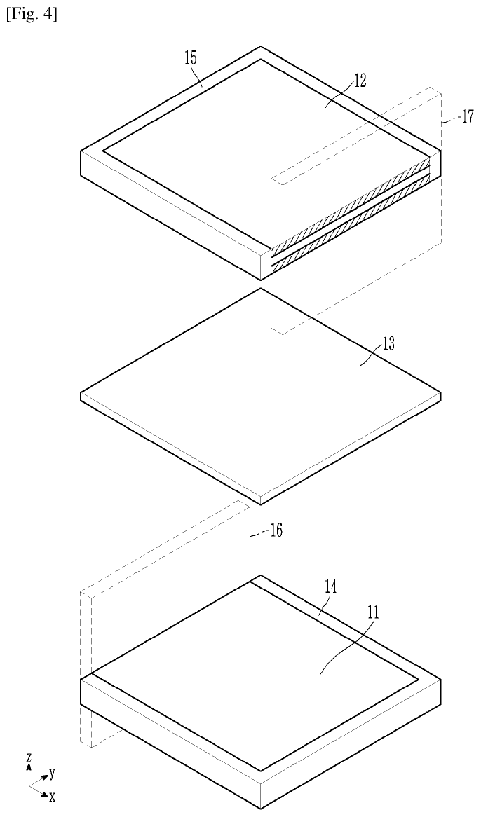

FIG. 4 is a partially exploded perspective view illustrating a partially disassembled all-solid-state battery according to Comparative Example.

Referring to FIG. 4, in the all-solid-state battery of Comparative Example, the positive electrode layer 11 and the negative electrode layer 12 are located on opposite sides to each other along the first direction (x-axis direction in the drawing).

Specifically, one edge of the positive electrode layer 11 may overlap a portion of one side (left) edge of the solid electrolyte layer 13 in the stacking direction, and the other three edges of the positive electrode layer 11 may overlap the insulating layer 14 in the planar direction. In this case, the insulating layer 14 may include three linear portions that are bent and integrally connected. One edge of the negative electrode layer 12 may overlap a portion of the other side (right) edge of the solid electrolyte layer 13 in the stacking direction, and the other three edges of the negative electrode layer 12 may contact the insulating layer 15 in the planar direction. In this case, the insulating layer 15 may include three linear portions that are bent and integrally connected.

An external positive electrode 16 may be connected to and coupled to one edge of the positive electrode layer 11 exposed to one side of the cell stack. An external negative electrode 17 may be connected to and coupled to one edge of the negative electrode layer 12 exposed to the opposite side of the cell stack. The external positive electrode 16 and the external negative electrode 17 face each other along the first direction.

Referring to FIGS. 3 and 4, in the all-solid-state battery of the Example embodiment and the all-solid-state battery of Comparative Example, when it is assumed that the areas of the solid electrolyte layers 130 and 13, the volume of the cell stack, and the widths of the insulating layers 151, 152, 14, and 15 are equal, the total area occupied by the electrode active material layers 122 and 142 in the all-solid-state battery 100 of the Example embodiment is larger than the entire area occupied by the electrode active material layer in the all-solid-state battery of Comparative Example.

Specifically, in the all-solid-state battery 100 of the Example embodiment, the areas occupied by the electrode active material layers 122 and 142 are larger than that of Comparative Example by the area occupied by one of two linear portions constituting the outer portions 126 and 146. Therefore, the all-solid-state battery 100 of the Example embodiment may increase the capacity of the electrode active material layers 122 and 142 to increase the battery capacity.

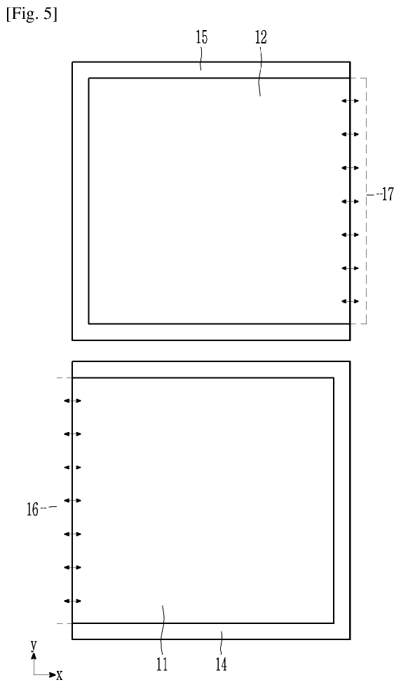

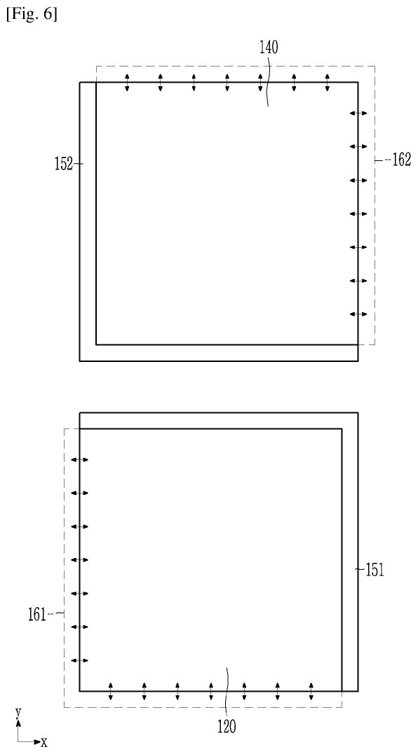

FIG. 5 is a diagram schematically illustrating an electron movement path between an electrode layer and an external electrode in the all-solid-state battery of Comparative Example illustrated in FIG. 4, and FIG. 6 is a diagram schematically illustrating the electron movement path between the electrode layer and the external electrode in the all-solid-state battery of the Example embodiment illustrated in FIG. 1.

Referring to FIG. 5, in the all-solid-state battery of Comparative Example, the external electrodes 16 and 17 are in contact with one edge of the electrode layers 11 and 12. In this case, the electron movement path is short around one edge close to the external electrodes 16 and 17 among the electrode active material layers, but the electron movement path becomes longer as the distance from the external electrodes 16 and 17 in the first direction increases.

Referring to FIGS. 1 and 6, in the all-solid-state battery 100 of the Example embodiment, the external electrodes 161 and 162 are continuously connected to two edges of the electrode layers 120 and 140, and a contact length between the external electrodes 161 and 162 and the electrode layers 120 and 140 is approximately twice as long as that of Comparative Example. Therefore, the all-solid-state battery 100 of the Example embodiment may shorten the electron movement path as a whole, and may increase the charge/discharge rate compared to the case of Comparative Example.

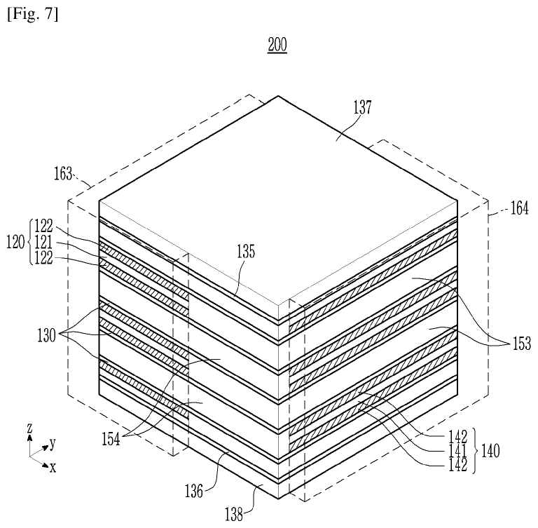

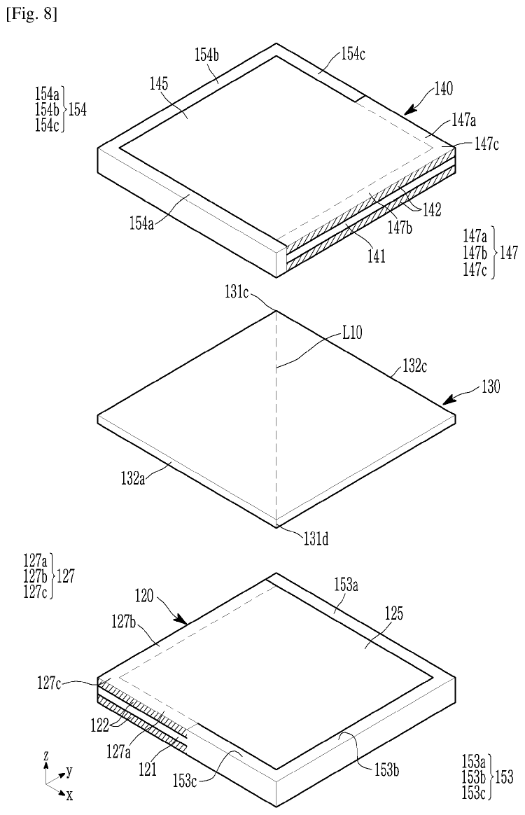

FIG. 7 is a perspective view illustrating an all-solid-state battery according to another embodiment, and FIG. 8 is a partially exploded perspective view illustrating a partially disassembled all-solid-state battery illustrated in FIG. 7.

Referring to FIGS. 7 and 8, an all-solid-state battery 200 according to the other embodiment may include the same basic configuration as the all-solid-state battery 100 described with reference to FIGS. 1 to 3. That is, in the all-solid-state battery 200, the positive electrode layer 120 and the negative electrode layer 140 may each include central portions 125 and 145 and outer portions 127 and 147 located outside the central portions 125 and 145. The central portions 125 and 145 may overlap the solid electrolyte layer 130 and other electrode layers in the stacking direction, and the outer portions 127 and 147 may overlap the solid electrolyte layer 130 in the stacking direction. The outer portions 127 and 147 have corner portions 127c and 147c located opposite sides to each other along the diagonal direction and do not overlap other electrode layers in the stacking direction. The entirety of the outer portions 127 and 147 are also located on opposite sides of each other along the diagonal direction, and face each other along the diagonal direction.

The outer portion 127 of the positive electrode layer 120 may include two linear portions that are bent and integrally connected, that is, a first linear portion 127a and a second linear portion 127b, and a corner portion 127c located between the first linear portion 127a and the second linear portion 127b. The insulating layer 153 in contact with the positive electrode layer 120 may include three linear portions that are bent and integrally connected, that is, a third linear portion 153a, a fourth linear portion 153b, and a fifth linear portion 153c. The first to fifth linear portions 127a, 127b, 153a, 153b, and 153c may form a quadrangular frame to surround the central portion 125 of the positive electrode layer 120 without gaps.

One edge of the central portion 125 may be in continuous contact with the first linear portion 127a and the fifth linear portion 153c, and the end portions of the first linear portion 127a and the fifth linear portion 153c may come into contact with each other. The edges of the first linear portion 127a and the fifth linear portion 153c may overlap the first edge portion 132a of the solid electrolyte layer 130 in the stacking direction. The first linear portion 127a and the fifth linear portion 153c may have the same length, but are not limited to this example. The external positive electrode 163 may be connected and coupled to two adjacent edges of the outer portion 127.

The outer portion 147 of the negative electrode layer 140 may include two linear portions that are bent and integrally connected, that is, a sixth linear portion 147a and a seventh linear portion 147b, and the corner portion 147c located between the sixth linear portion 147a and the seventh linear portion 147b. The insulating layer 154 in contact with the negative electrode layer 140 may include three linear portions that are bent and integrally connected, that is, an eighth linear portion 154a, a ninth linear portion 154b, and a tenth linear portion 154c. The sixth to tenth linear portions 147a, 147b, 154a, 154b, and 154c may form a quadrangular frame to surround the central portion 145 of the negative electrode layer 140 without gaps.

One edge of the central portion 145 may be in continuous contact with the sixth linear portion 147a and the tenth linear portion 154c, and the end portions of the sixth linear portion 147a and the tenth linear portion 154c may come into contact with each other. The edges of the sixth linear portion 147a and the tenth linear portion 154c may overlap the third edge portion 132c of the solid electrolyte layer 130 in the stacking direction. The sixth linear portion 147a and the tenth linear portion 154c may have the same length, but are not limited to this example. The external negative electrode 164 may be connected and coupled to two edges of the outer portion 147.

The length of the first linear portion 127a may be the same as that of the sixth linear portion 147a. The positive electrode layer 120 and the negative electrode layer 140 may be symmetrical with respect to an imaginary line L10 connecting vertices of the third corner portion 131c and the fourth corner portion 131d.

The all-solid-state battery 200 according to the embodiment has a smaller total area occupied by the electrode active material layers 122 and 142 than the all-solid-state battery 100 described with reference to FIGS. 1 to 3, but may secure a large distance between the external positive electrode 163 and the external negative electrode 164, thereby reducing the interference between the external positive electrode 163 and the external negative electrode 164.

Resistances of the external electrodes in the all-solid-state batteries according to Examples 1 and 2 and Comparative Examples were measured and shown in Table 1. The all-solid-state battery of Example 1 is the all-solid-state battery according to the Example embodiment described with reference to FIGS. 1 to 3, and the all-solid-state battery of Example 2 is the all-solid-state battery according to the other embodiment described with reference to FIGS. 7 and 8.

TABLE 1

| | | | Comparative |
|---|---|---|---|
| | Example 1 | Example 2 | Example |
| Resistance (kΩ) | 3.2 | 5.6 | 9.3 |

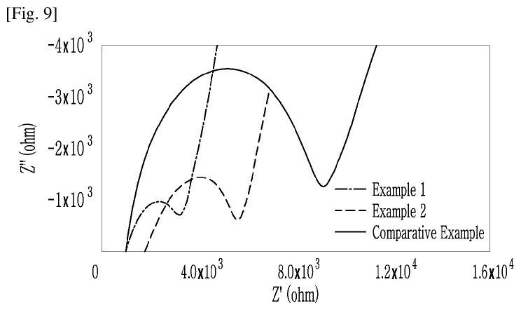

FIG. 9 is a graph showing results of a cole-cole plot of the all-solid-state batteries according to Examples 1 and 2 and Comparative Example.

Referring to FIG. 9 and Table 1, it can be seen that the resistance of the external electrode is the highest in the all-solid-state battery of Comparative Example, the lowest in the all-solid-state battery of Example 1, and an intermediate level in the all-solid-state battery of Example 2. The all-solid-state batteries of Examples 1 and 2 may lower the resistance of the external electrode to increase the charge/discharge rate.

Although preferred embodiments have been described above, the present invention is not limited thereto, and the present invention can be variously modified within the scope of the claims, the detailed description of the invention, and the appended drawings, and it is natural that various modifications also fall within the scope of the present invention.

### DESCRIPTION OF SYMBOLS

100, 200: All-solid-state battery
120, 140: Electrode layer
120: Positive electrode layer
121: Positive electrode current collector
122: Positive electrode active material layer
140: Negative electrode layer
141: negative electrode current collector
142: negative electrode active material layer
125, 145: Central portion 126, 127, 146, 147: Outer portion
151, 152, 153, 154: Insulating layer 130: Solid electrolyte layer
135, 136: Outer insulating layer 137, 138: Protective layer
161, 162: External electrode
161, 163: External positive electrode
162, 164: External negative electrode

1. An all-solid-state battery, comprising:
a solid electrolyte layer; and
a first electrode layer and a second electrode layer disposed in a stacking direction with the solid electrolyte layer interposed therebetween, and having different polarities,
wherein each of the first electrode layer and the second electrode layer includes a central portion and an outer portion located outside the central portion,
the central portions of the first electrode layer and the second electrode layer overlap each other and overlap the solid electrolyte layer in the stacking direction, and
the outer portion of each of the first electrode layer and the second electrode layer overlap the solid electrolyte layer in the stacking direction, and have a corner portion located on opposite sides to each other along a diagonal direction in different electrode layers.

2. The all-solid-state battery of claim 1, wherein:
the central portion includes four edges, and
the outer portion includes two linear portions that are bent at the corner portion and integrally connected, and is in contact with a whole of two adjacent edges of the central portion.

3. The all-solid-state battery of claim 2, further comprising:
an insulating layer in contact with each of the first electrode layer and the second electrode layer in a planar direction,
wherein the insulating layer includes two linear portions that are bent and integrally connected, and is in contact with an entirety of remainder of the edges of the central portion and an end portion of the outer portion.

4. The all-solid-state battery of claim 1, wherein:
the central portion includes four edges, and
the outer portion includes two linear portions that are bent at the corner portion and integrally connected, and is in contact with an entirety of one edge and a portion of a remaining edge of the central portion.

5. The all-solid-state battery of claim 4, further comprising:
an insulating layer in contact with each of the first electrode layer and the second electrode layer in a planar direction,
wherein the insulating layer includes three linear portions that are bent and integrally connected, and is in contact with an entirety of remaining adjacent edges of the central portion, the rest of the remaining edge, and an end portion of the outer portion.

6. The all-solid-state battery of claim 1, wherein:
the solid electrolyte layer includes two corner portions facing in a diagonal direction, and
the first electrode layer and the second electrode layer are symmetrical to each other based on an imaginary line connecting vertices of the two corner portions.

7. The all-solid-state battery of claim 1, wherein:
the solid electrolyte layer includes a first corner portion and a second corner portion facing in a diagonal direction,
the corner portion of the outer portion of the first electrode layer overlaps the first corner portion in the stacking direction, and
the corner portion of the outer portion of the second electrode layer overlaps the second corner portion in the stacking direction.

8. The all-solid-state battery of claim 7, wherein:
the solid electrolyte layer includes a first edge portion and a second edge portion in contact with the first corner portion, and a third edge portion and a fourth edge portion in contact with the second corner portion,
an outer portion edge of the first electrode layer overlaps a portion of the first edge portion and a portion of the second edge portion in the stacking direction, and
an outer portion edge of the second electrode layer overlaps a portion of the third edge portion and a portion of the fourth edge portion in the stacking direction.

9. The all-solid-state battery of claim 8, further comprising:
a first insulating layer and a second insulating layer in contact with each of the first electrode layer and the second electrode layer in a planar direction,
wherein an edge of the first insulating layer overlaps the rest of the first edge portion, the rest of the second edge portion, the third edge portion, and the fourth edge portion in the stacking direction, and
an edge of the second insulating layer overlaps the first edge portion, the second edge portion, the rest of the third edge portion, and the rest of the fourth edge portion in the stacking direction.

10. The all-solid-state battery of claim 9, wherein:
the outer portions of the first electrode layer and the second electrode layer and each of the first insulating layer and the second insulating layer include two linear portions that are bent and integrally connected.

11. The all-solid-state battery of claim 10, wherein:
the outer portion of the first electrode layer and the first insulating layer form a quadrangular frame to surround the central portion of the first electrode layer, and
the outer portion of the second electrode layer and the second insulating layer form a quadrangular frame to surround the central portion of the second electrode layer.

12. The all-solid-state battery of claim 9, wherein:
the outer portions of the first electrode layer and the second electrode layer include two linear portions that are bent at the corner portion and integrally connected, and
each of the first insulating layer and the second insulating layer includes three linear portions that are bent and integrally connected.

13. The all-solid-state battery of claim 12, wherein:
the outer portion of the first electrode layer and the first insulating layer form a quadrangular frame to surround the central portion of the first electrode layer, and
the outer portion of the second electrode layer and the second insulating layer form a quadrangular frame to surround the central portion of the second electrode layer.

14. An all-solid-state battery, comprising:
a solid electrolyte layer;
a first electrode layer and a second electrode layer disposed in a stacking direction with the solid electrolyte layer interposed therebetween, and having different polarities, and
a first external electrode and a second external electrode connected to the first electrode layer and the second electrode layer, respectively, wherein each of the first electrode layer and the second electrode layer includes a central portion and an outer portion located outside the central portion,
the central portion overlaps the solid electrolyte layer and different electrode layers in the stacking direction,
the outer portion includes corner portions overlapping the solid electrolyte layer in the stacking direction and located on opposite sides to each other along a diagonal direction in different electrode layers, and two linear portions that are bent at the corner portion and integrally connected, and
the first external electrode and the second external electrode are connected to two adjacent edges of the outer portion.

15. The all-solid-state battery of claim 14, further comprising:
a first insulating layer in contact with the first electrode layer in a planar direction and having two linear portions that are bent and integrally connected,
wherein the outer portion of the first electrode layer and the first insulating layer form a quadrangular frame to surround the central portion of the first electrode layer.

16. The all-solid-state battery of claim 15, further comprising:
a second insulating layer in contact with the second electrode layer in a planar direction and having two linear portions that are bent and integrally connected,
wherein the outer portion of the second electrode layer and the second insulating layer form a quadrangular frame to surround the central portion of the second electrode layer.

17. The all-solid-state battery of claim 14, further comprising:
a first insulating layer in contact with the first electrode layer in a planar direction and having three linear portions that are bent and integrally connected,
wherein the outer portion of the first electrode layer and the first insulating layer form a quadrangular frame to surround the central portion of the first electrode layer.

18. The all-solid-state battery of claim 17, further comprising:
a second insulating layer in contact with the second electrode layer in a planar direction and having three linear portions that are bent and integrally connected,
wherein the outer portion of the second electrode layer and the second insulating layer form a quadrangular frame to surround the central portion of the second electrode layer.

19. The all-solid-state battery of claim 14, wherein:
the solid electrolyte layer includes two corner portions facing in a diagonal direction, and
the outer portions of the first electrode layer and the second electrode layer are symmetrical to each other based on an imaginary line connecting vertices of the two corner portions.

20. The all-solid-state battery of claim 14, wherein:
the solid electrolyte layer, the first electrode layer, and the second electrode layer constitute a cell stack,
the solid electrolyte layer includes a first corner portion and a second corner portion facing in a diagonal direction,
the first external electrode surrounds the first corner portion and contacts two adjacent side surfaces of the cell stack, and
the second external electrode surrounds the second corner portion and contacts remaining two adjacent side surfaces of the cell stack.
